(19) United States
(12) Patent Application Publication
(10) Pub. No.: US 2005/0000726 A1
(43) Pub. Date: Jan. 6, 2005

(54) Resin encapsulated electronic component unit and method of manufacturing the same

(75) Inventors: Ryuichi Kimata, Wako-shi (JP); Tsutomu Wakitani, Wako-shi (JP); Kousei Yamashita, Wako-shi (JP); Hironori Kato, Wako-shi (JP)

Correspondence Address: BIRCH STEWART KOLASCH & BIRCH, PO BOX 747, FALLS CHURCH, VA, 22040-0747, US

(73) Assignee: HONDA MOTOR CO., LTD., Tokyo (JP)

(21) Appl. No.: 10/859,173

(22) Filed: Jun. 3, 2004

(30) Foreign Application Priority Data
Jun. 6, 2003 (JP) 2003-161444
Jun. 6, 2003 (JP) 2003-161445
Jun. 6, 2003 (JP) 2003-161448

(51) Int. Cl. B29C 31/04

(52) U.S. Cl. 174/256; 264/272.14; 29/841

(57) ABSTRACT

A resin encapsulated electronic component unit and method includes a printed wiring board, mounted electronic components, and a resin coating layer, which covers and encapsulates the electronic components by insert molding. The resin coating layer is formed from a thermoplastic resin. The resin encapsulated electronic component unit includes accessory members, which are molded from the thermoplastic resin. The insert molding is performed by use of molds including cavities in which the board is disposed and hollow portions corresponding to the accessory members and by injecting the thermoplastic resin into the hollow portion and discharging air from the hollow portion so that the thermoplastic resin flows longitudinally of the board. The resin coating layer is disposed on both front and back surfaces of the board and the amount of thermoplastic resin is substantially symmetrically disposed on both front and back surfaces of the board.

### BACKGROUND OF THE INVENTION

1. Field of the Invention

The present invention relates to a resin encapsulated electronic component unit which is obtained by coating and encapsulating, with a resin coating layer, a printed wiring board on which electronic components, such as capacitors and cable connection members, are mounted, and a method of manufacturing this resin encapsulated electronic component unit.

2. Description of the Related Art

In order to protect a printed wiring board, on which electronic components such as capacitors and cable connection members are mounted, from water, moisture or dust, there has hitherto been known a resin encapsulated electronic component unit which is obtained by coating and encapsulating the board with a resin coating layer.

Some of the above-described resin encapsulated electronic component units, for example, have the whole of the above-described printed wiring board, on which electronic components are mounted, coated with a resin such as an epoxy resin. Such a resin encapsulated electronic component unit is manufactured, as described in the Japanese Utility Model Registration No. 6-11535, for example, by housing the above-described printed wiring board in a case and injecting an epoxy resin into the case.

The above-described epoxy resin is excellent in environmental resistance and has good adhesion to the above-described printed wiring board. Therefore, the above-described resin encapsulated electronic component unit has excellent waterproof, moisture-proof or dustproof performance. However, because the above-described epoxy resin is a thermosetting resin, it is necessary to hold this resin at a temperature of not less than 100° C. for several hours after it is injected into the above-described case. Therefore, the manufacturing of the above-described resin encapsulated electronic component unit by using the above-described epoxy resin has the problem that the work efficiency is low and that the upsizing of equipment is unavoidable.

Furthermore, when manufacturing is performed in a manner as described above, a resin is injected into a case which houses the above-described printed wiring board and, therefore, it is necessary to inject the resin in an amount large enough to bury the tallest component among the electronic components mounted on the above-described printed wiring board. Therefore, this manufacturing method has the problem that the amount of the above-described resin to be injected cannot be reduced less than the amount necessary for embedding the above-described tallest component.

In order to solve the above-described problems, in the Japanese Patent Laid-Open No. 2000-133665 is proposed a technique by which a printed wiring board on which electronic components are mounted is coated by the insert molding of a thermoplastic resin. According to the above-described technique, it is possible to obtain a resin encapsulated electronic component unit by forming resin coating layer of the above-described thermoplastic resin and coating and encapsulating this board with the resin coating layer.

The above-described insert molding is performed by disposing the above-described printed wiring board within a cavity of a mold and injecting a thermoplastic resin such as a polyamide resin into this cavity. The above-described thermoplastic resin such as a polyamide resin melts at relatively low temperatures and can be injected at relatively low pressures. Therefore, according to the above-described insert molding, it is possible to prevent electronic components mounted on the above-described printed wiring board from being damaged by heat and pressure during molding.

However, the above-described insert molding has the disadvantage that the above-described thermoplastic resin injected into the above-described mold is divided into multiple streams within the above-described cavity, which flow around within the cavity, forming weld lines at points where the streams join together. If the above-described weld lines are formed in the above-described resin coating layer, cracks are liable to start at the weld lines when stresses are applied after molding.

### SUMMARY OF THE INVENTION

An object of the present invention is to provide a resin encapsulated electronic component unit in which a resin coating layer formed by insert molding has no weld line and is less apt to develop cracks even when stresses are applied.

A further object of the present invention is to provide a method of manufacturing a resin encapsulated electronic component unit which can prevent the occurrence of the above-described weld line.

To achieve these objects, a resin encapsulated electronic component unit of the present invention comprising a rectangular printed wiring board, electronic components mounted on the board, and a resin coating layer which covers the electronic components by insert molding and encapsulates the electronic components, which comprises: a resin coating layer formed from a thermoplastic resin whose temperature at a surface of the printed wiring board during the insert molding is lower than the melting temperature of a solder used in mounting the electronic components; and accessory members which are connected to both end portions of narrow sides of the printed wiring board and molded integrally with the resin coating layer from the thermoplastic resin; the resin coating layer being formed by causing the thermoplastic resin to flow from the side of one accessory member to the side of the other accessory member.

The above-described resin encapsulated electronic component unit can be advantageously manufactured by the following manufacturing method. In the above-described manufacturing method, the insert molding is performed by use of a mold which comprises a cavity in which the printed wiring board is disposed and hollow portions corresponding to the shape of the accessory members between each end portion on narrow sides of the above-described printed wiring board disposed within the cavity and an inner wall of the cavity, by injecting the thermoplastic resin into one hollow portion and discharging gases in the cavity from the other hollow portion so that the thermoplastic resin flows within the cavity longitudinally of the board.

In the manufacturing method of the present invention, the above-described rectangular printed wiring board is disposed within the cavity of the above-described printed wiring board. And the above-described thermoplastic resin is injected from a hollow portion corresponding to the shape of the above-described accessory member provided on one narrow side of the above-described board and gases in the cavity are discharged from the above-described hollow portion provided on the other narrow side.

As a result, the above-described thermoplastic resin flows within the above-described cavity longitudinally of the above-described board and the thermoplastic resin is filled in the cavity without being divided into multiple currents. Therefore, points where the multiple streams join together are-not formed within the above-described cavity and it is possible to prevent weld lines from occurring in the above-described resin coating layer.

The above-described accessory members are, for example, attaching members which attach the above-described resin encapsulated electronic component unit in a predetermined position.

Incidentally, the above-described electronic components are mounted on the above-described printed wiring board generally by soldering. The above-described solder is, for example, an alloy of Pb 60 wt % and Sn 40 wt %. Therefore, if the temperature of the above-described thermoplastic resin is higher than the melting temperature of the above-described solder during the above-described insert molding, then it is feared that the solder might melt.

In this respect, in the present invention, by using a thermoplastic resin whose temperature at a surface of the above-described printed wiring board during the above-described insert molding is lower than the melting temperature of a solder used in mounting the above-described electronic components, the melting of the above-described solder can be prevented. For example, a polyamide resin and a polyester resin can be used as the above-described thermoplastic resin.

Even when the above-described thermoplastic resin is used, the temperature of the thermoplastic resin becomes relatively high near a gate when the thermoplastic resin is injected into the above-described cavity. Therefore, when the above-described electronic components are present near the above-described gate, the electronic components are exposed to the thermoplastic resin at a relatively high temperature until the injection of the above-described thermoplastic resin is completed, with the result that the above-described solder may sometimes melt.

In the above-described manufacturing method, however, the above-described thermoplastic resin is injected into the above-described hollow portion and, therefore, the thermoplastic resin is cooled within the hollow portion, with the result that the temperature of the thermoplastic resin decreases sufficiently before the thermoplastic resin reaches points where the above-described electronic components of the above-described printed wiring board are mounted. Therefore, it is possible to prevent the above-described electronic components from being subjected to the above-described thermoplastic resin at a relatively high temperature while the thermoplastic resin is being injected.

Because a resin encapsulated electronic component unit of the present invention obtained as described above has the above-described resin coating layer free from a weld line, the resin coating layer is less apt to develop cracks even when stresses are applied and it is possible to obtain excellent waterproofness, moisture-proofness and dustproofness.

Incidentally, it is feared that the above-described resin coating layer might undergo heat contraction during cooling and hardening, with the result that deformation such as bowing might occur on the above-described printed wiring board due to stresses caused by the heat contraction.

Therefore, in a resin encapsulated electronic component unit of the present invention, the above-described resin coating layer is disposed on both front and back surfaces of the above-described printed wiring board and the amount of the above-described thermoplastic resin which forms the resin coating layer is substantially symmetrically disposed on both front and back surfaces of the printed wiring board.

Because in a resin encapsulated electronic component unit of the present invention, the amount of the above-described thermoplastic resin which forms the above-described resin coating layer is substantially symmetrically disposed on both front and back surfaces of the above-described printed wiring board, the amount of the thermoplastic resin becomes almost equal on both front and rear surfaces of the printed wiring board. Therefore, stresses during the cooling and hardening of the above-described thermoplastic resin become almost equal on both front and back surfaces of the above-described printed wiring board and hence it becomes possible to prevent the board from being deformed by the above-described stresses.

Such a resin encapsulated electronic component unit as described above can be advantageously manufactured by the following manufacturing method. In the above-described manufacturing method, the above-described insert molding is performed by use of a mold having a shape which ensures that the amount of the above-described thermoplastic resin which forms the above-described resin coating layer disposed on both front and back surfaces of the above-described printed wiring board is substantially symmetrically disposed on both front and back surfaces of the printed wiring board, and by disposing the printed wiring board within the cavity and simultaneously injecting the above-described thermoplastic resin to the sides of both front and back surfaces of the printed wiring board.

It is preferred that in a resin encapsulated electronic component unit in which the amount of the above-described thermoplastic resin forming the above-described resin coating layer is substantially symmetrically disposed on both front and back surfaces of the above-described printed wiring board, the above-described resin coating layer have a shape which matches contours of the above-described electronic components. Because the above-described resin coating layer has a shape which matches contours of the above-described electronic components, it is possible to reduce the required amount of the above-described thermoplastic resin forming the resin coating film.

Such a resin encapsulated electronic component unit as described above can be advantageously manufactured by the following manufacturing method. In the above-described manufacturing method, the above-described insert molding is performed by use of a mold comprising a cavity having a shape which matches a contour of the above-described printed wiring board on which the above-described electronic components are mounted.

Incidentally, in addition to the problem that the above-described thermoplastic resin injected into the above-described mold forms the above-described weld line, the above-described insert molding has the problem that the streams of the thermoplastic resin may sometimes entrap air and form voids. If the above-described voids are formed in the above-described resin coating layer, in a case where stresses are added after molding, cracks are liable to start at the voids, as with the above-described weld line.

In the above-described insert molding, in some manners of the arrangement of electronic components mounted on the above-described printed wiring board, the electronic components may sometimes be damaged by the pressure of the above-described thermoplastic resin injected into the above-described cavity during molding.

Therefore, a resin encapsulated electronic component unit of the present invention can be advantageously manufactured by the following manufacturing method. In the above-described manufacturing method, the above-described insert molding is performed by disposing within the cavity of the above-described mold, a printed wiring board on which a plurality of mounted electronic components are longitudinally arranged and a channel of the above-described thermoplastic resin is provided in a middle portion of width direction, and injecting the thermoplastic resin into one hollow portion and discharging gases in the cavity from the other hollow portion so that the thermoplastic resin is guided into the channel within the cavity and flows longitudinally of the printed wiring board.

The electronic components mounted on the above-described printed wiring board include relatively tall components, such as capacitors and cable connection members such as connectors. If such electronic components are disposed on the channel of the above-described thermoplastic resin, the flow of the thermoplastic resin is branched by the electronic components and divided into multiple streams, with the result that weld lines are liable to be formed in points where the streams join together. Furthermore, if the flow of the above-described thermoplastic resin is interfered with by the above-described electronic components, then the flow of the thermoplastic resin is liable to entrap air when the flow of the thermoplastic resin moves around the electronic components, with the result that the above-described voids are liable to be formed. Furthermore, if the above-described electronic components interfere with the flow of the above-described thermoplastic resin, the electronic components may sometimes be damaged by the pressure of the flow of the thermoplastic resin.

Therefore, in the above-described manufacturing method, the above-described insert molding is performed by disposing, within the cavity of the mold, the above-described printed wiring board in which the above-described plurality of electronic components are arranged longitudinally of the printed wiring board and in a middle portion of the width direction of the printed wiring board is formed a nonmounted area which is longitudinally configured. Because in the above-described printed wiring board the above-described electronic components are arranged longitudinally of the board, the above-described nonmounted area which is formed in a middle portion of the width direction of the printed wiring board provides the channel of the above-described thermoplastic resin. As a result, when the above-described thermoplastic resin is injected from the above-described hollow portion on one narrow side of the above-described board and gases in the cavity are discharged from the above-described hollow portion on the other narrow side, the thermoplastic resin flows smoothly in the above-described channel longitudinally of the printed wiring board.

Therefore, in the above-described manufacturing method, the flow of the above-described thermoplastic resin is less apt to be branched or interfered with by the above-described electronic components and the occurrence of weld lines and voids can be substantially suppressed. Furthermore, in the above-described manufacturing method, the channel of the above-described thermoplastic resin is formed in the above-described printed wiring board and, therefore, the above-described electronic components are less apt to be subjected to the pressure of the thermoplastic resin which is injected into the above-described cavity, with the result that it is possible to prevent damage to the electronic components due to the pressure.

This manufacturing method can be advantageously carried out by using a rectangular printed wiring board on which a plurality of electronic components are mounted, in which a plurality of the electronic components are arranged longitudinally of the printed wiring board and in a middle portion of the width direction of the printed wiring board is formed a nonmounted area which is longitudinally configured.

### BRIEF DESCRIPTION OF THE DRAWINGS

FIG. 1 is a plan view of an embodiment of a resin encapsulated electronic component unit of the present invention;

FIG. 2 is a plan view of an embodiment of a printed wiring board used in a method of manufacturing a resin encapsulated electronic component unit of the present invention; and

FIG. 3 is a schematic sectional view of an embodiment of a method of manufacturing a resin encapsulated electronic component unit of the present invention.

### DETAILED DESCRIPTION OF THE PREFERRED EMBODIMENTS

Next, embodiments of the present invention will be described in further detail by referring to the accompanying drawings.

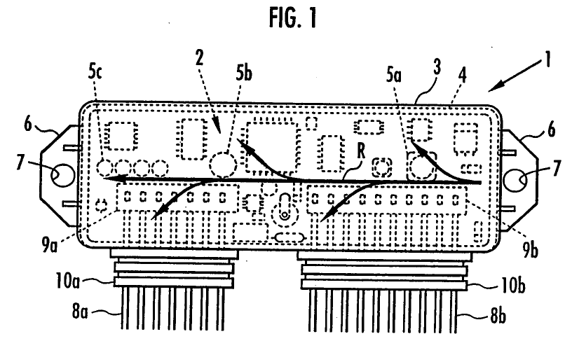

As shown in FIG. 1, a resin encapsulated electronic component unit 1 of this embodiment comprises a resin coating layer 3 on both front and back surfaces of a mounted printed wiring board 2. The mounted printed wiring board 2 is obtained by mounting a plurality of electronic components 5a, 5b, 5c such as semiconductors, LSIs and capacitors on one surface of a rectangular printed wiring board 4 by soldering.

The resin encapsulated electronic component unit 1 has attaching flanges 6 which are molded integrally with the resin coating layer 3 so as to be connected to both end portions of narrow sides of the printed wiring board 4, and an attaching hole 7 is provided in each of the flanges 6. Furthermore, the printed wiring board 4 is provided, on the surface thereof, with cable connection members 9a, 9b to which a plurality of groups of input/output cables 8a, 8b are connected, and the groups of cables 8a, 8b are pulled out of the printed wiring board 4 one by one via grommets 10a, 10b which are molded integrally with the resin coating layer 3 so as to be connected to the end portions of wide side of the printed wiring board 4. Incidentally, in this embodiment, the description will be given by regarding also the cable connection members 9a, 9b as electronic components.

In the mounted printed wiring board 2, tall electronic components such as capacitors 5a, 5b, 5c are arranged longitudinally of the rectangular printed wiring board 4, the cable connection members 9a, 9b are arranged parallel to the electronic components 5a, 5b, 5c, and a nonmounted area is provided between the electronic components 5a, 5b, 5c and the cable connection members 9a, 9b.

The resin coating layer 3 is formed from a thermoplastic resin whose temperature at a surface of the mounted printed wiring board 2 during the molding is lower than the melting temperature of a solder used in mounting the electronic components 5a, 5b, 5c. The above-described thermoplastic resin is, for example, a polyamide resin.

The resin encapsulated electronic component unit 1 of this embodiment is formed from a polyamide resin R which flows, as shown by the arrows in FIG. 1, from one flange 6 to the other flange 6. The above-described polyamide resin R flows using the above-described nonmounted area between the row of the electronic components 5a, 5b, 5c and the row of the cable connection members 9a, 9b as the channel. And the above-described polyamide resin R flows so as to spread from the above-described channel to both sides of width direction of the mounted printed wiring board 2.

As described above, the resin coating layer 3 is disposed on both front and back surfaces of the mounted printed wiring board 2 and the amount of the above-described polyamide resin R which forms the resin coating layer 3 is substantially symmetrically disposed on both front and back surfaces of the printed wiring board 2.

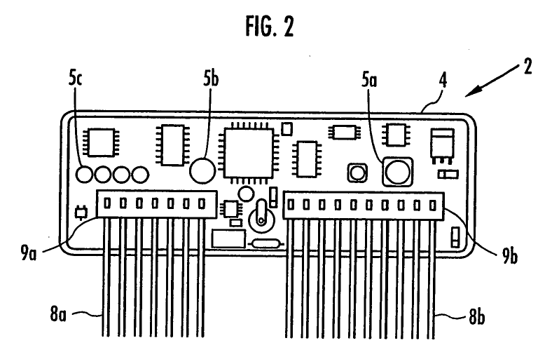

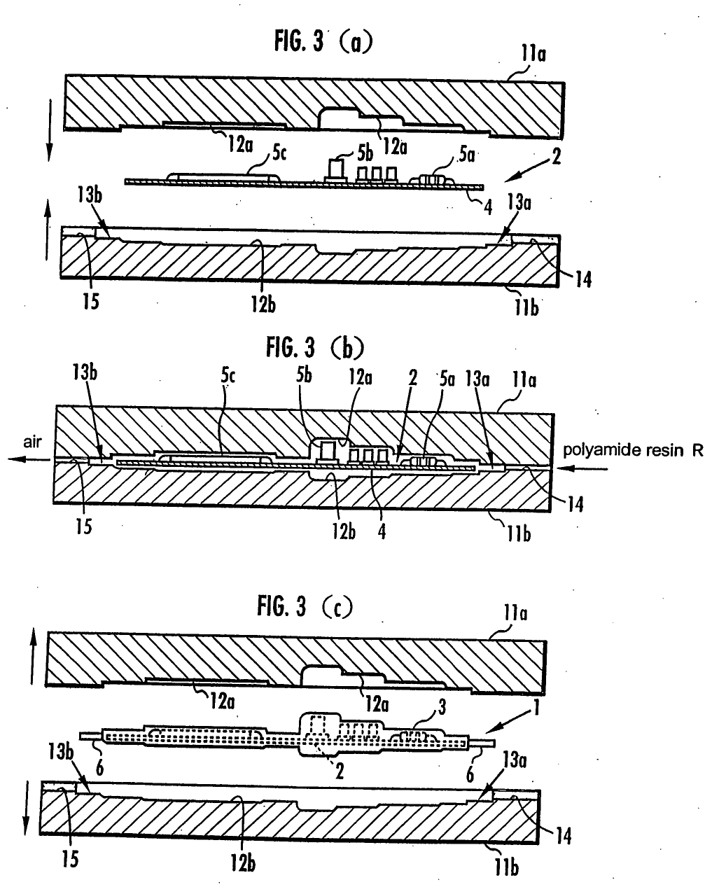

Next, a method of manufacturing the resin encapsulated electronic component 1 shown in FIG. 1 will be described below by referring to FIG. 2 and FIG. 3.

In a method of manufacturing a resin encapsulated electronic component of this embodiment, the mounted printed wiring board 2 shown in FIG. 2 is coated with the resin coating layer 3. In the mounted printed wiring board 2, as described above, the plurality of electronic components 5a, 5b, 5c such as semiconductors, LSIs and capacitors are mounted on one surface of the rectangular printed wiring board 4, and the plurality of groups of input/output cables 8a, 8b are connected to the cable connection members 9a, 9b provided on the surface. The tall electronic components 5a, 5b, 5c such as capacitors are arranged longitudinally of the rectangular printed wiring board 4, and the cable connection members 9a, 9b are arranged parallel to the electronic components 5a, 5b, 5c. Incidentally, the mounted printed wiring board 2 is not provided with the mounting flanges 6 or the grommets 10a, 10b.

In a method of manufacturing a resin encapsulated electronic component unit of this embodiment, first as shown in FIG. 3(a), the mounted printed wiring board 2 shown in FIG. 2 is disposed in cavities 12a, 12b of aluminum molds 11a, 11b. Incidentally, FIGS. 3(a) to 3(c) all schematically show the above-described cavities 12a, 12b and mounted printed wiring board 2 and there are portions which do not agree with the constructions shown in FIGS. 1 and 2.

The cavity 12a of the mold 11a has a shape which matches the contour of the mounted printed wiring board 2, more specifically, a shape which matches the contour of the electronic components 5a, 5b, 5c and cable connection members 9a, 9b mounted on the printed wiring board 4.

On the other hand, the cavity 12b of the mold 11b is provided with flange formation portions 13a, 13b for forming the flanges 6 between both end portions of short sides of the mounted printed wiring board 2 and the inner wall of the mold 11b opposed to the end portions. The mold 11b is provided with a runner 14 which is in communication with one flange formation portion 13a and injects the above-described polyamide resin R and an air vent 15 which is in communication with the other flange formation portion 13b and discharges air in the cavities 12a, 12b to outside.

The cavities 12a, 12b have a shape which ensures that the amount of the above-described polyamide resin R which is introduced is substantially symmetrically disposed on both front and back surfaces of the mounted printed wiring board 2. As a result of this, in a manufacturing method of this embodiment, in the resin coating layer 3 formed by the cavities 12a, 12b, the amount of the above-described polyamide resin R is almost equal on both front and back surfaces of the mounted printed wiring board 2 and hence it is possible to suppress the deformation of the mounted printed wiring board 2 due to stresses during the cooling and hardening of the polyamide resin R.

The above-described expression “substantially symmetrically” means that it is necessary only that the amount be large enough to suppress the deformation of the mounted printed wiring board 2 due to stresses during the cooling and hardening of the polyamide resin R, and the amount of the above-described polyamide resin R which is introduced is not necessarily be completely symmetrically disposed on both front and back surfaces of the mounted printed wiring board 2.

Incidentally, the cavities 12a, 12b of the molds 11a, 11b are further provided, on one end portion of wide side of the mounted printed wiring board 2, with grommet formation portions (not shown) for forming the grommets 10a, 10b.

Next, as shown in FIG. 3(b), the molds 11a, 11b are closed. At this time, the mounted printed wiring board 2 is held by holding pins (not shown) in a predetermined position.

Next, by injecting the above-described polyamide resin R from the gate provided at the boundary between the runner 14 and the cavities 12a, 12b, the polyamide resin R is introduced into the cavities 12a, 12b. The above-described polyamide resin R is beforehand heated to a temperature of 210 to 220° C. and melted within a storage tank not shown in the figure and by use of a pressure feed pump provided within the storage tank the polyamide resin R is fed to the runner 14 at a pressure of about 1 to 4 MPa. As a result of this, the temperature of the above-described polyamide resin R becomes about 160° C. when the polyamide resin R reaches the surface of the mounted printed wiring board 2 held within the cavities 12a, 12b. This temperature is lower than the melting point of a solder (for example, Pb:Sn=6:4 (weight ratio)) used in the mounting of the electronic components 5a, 5b, 5c.

During the injection of the above-described polyamide resin R, the mounted printed wiring board 2 is held in a position opposed to the runner 14 in the cavities 12a, 12b. Therefore, the above-described polyamide resin R is simultaneously injected to both front and back surface sides of the mounted printed wiring board 2.

At this time, in the mounted printed wiring board 2, as described above, the row of the electronic components 5a, 5b, 5c and the row of the cable connection members 9a, 9b are longitudinally formed and a nonmounted area is formed between the electronic components 5a, 5b, 5c and the cable connection members 9a, 9b. Therefore, as shown in FIG. 1, the above-described polyamide resin R flows in a middle portion of width direction of the mounted printed wiring board 2 using the above-described nonmounted area between the row of the electronic components 5a, 5b, 5c and the row of the cable connection members 9a, 9b as the channel.

On the other hand, the air in the cavities 12a, 12b is discharged from the air vent 15 provided on the side corresponding to the flange formation portion 13b as the above-described polyamide resin R is introduced into the cavities 12a, 12b. As a result of this, the above-described polyamide resin R flows in the above-described channel longitudinally of the mounted printed wiring board 2 and simultaneously flows so as to spread from the above-described channel to both sides of width direction of the mounted printed wiring board 2, thereby forming the resin coating layer 3. Therefore, the flow of the polyamide resin R in the cavities 12a, 12b scarcely forms points of joining due to mutual collision anymore and it is possible to suppress the occurrence of weld lines in the formed resin coating layer 3.

Because the flow of the polyamide resin R is less apt to be interfered with by the electronic components 5a, 5b, 5c and the cable connection members 9a, 9b, it is possible to suppress the occurrence of voids by reducing the entrapment of air. Furthermore, because the electronic components 5a, 5b, 5c and the cable connection members 9a, 9b are arranged in positions where they are less apt to interfere with the flow of the polyamide resin R, the pressure of the flow of the polyamide resin R is substantially reduced.

The above-described polyamide resin R introduced into the cavities 12a, 12b releases heat in a short time via the aluminum molds 11a, 11b, is cooled and hard end, thereby forming the resin coating layer 3 which covers the mounted printed wiring board 2. At this time, the attaching flanges 6 and the grommets 10a, 10b are molded integrally with the resin coating layer 3.

Incidentally, the above-described holding pins are withdrawn the instant once the mounted printed wiring board 2 is supported by the above-described introduced polyamide resin R, and the polyamide resin R is filled in the traces of the holding pins. Therefore, the traces of the above-described holding pins do not remain in the resin coating layer 3.

Next, when the above-described polyamide resin R has been cooled and hardened, as shown in FIG. 3(c), the molds 11a, 11b are opened and the resin encapsulated electronic component unit 1 in which the mounted printed wiring board 2 is covered with the resin coating layer 3 is taken out.

In the resin encapsulated electronic component unit 1 of this embodiment, the occurrence of weld lines and voids is substantially suppressed in the resin coating layer 3 as described above and, therefore, cracks are less apt to occur when stresses are applied.

On the side where the electronic components 5a, 5b, 5c and cable connection members 9a, 9b of the mounted printed wiring board 2 are mounted, the resin coating layer 3 has a shape which matches the contours of the electronic components 5a, 5b, 5c and cable connection members 9a, 9b. On the side opposite to the side where the electronic components 5a, 5b, 5c and cable connection members 9a, 9b of the mounted printed wiring board 2 are mounted, the amount of the resin of each part of the resin coating layer 3 is disposed substantially symmetrically with the side where the electronic components 5a, 5b, 5c and cable connection members 9a, 9b are mounted.

Specifically, in portions where the resin coating layer 3 is formed thick by coating the electronic components 5a, 5b, 5c and the cable connection members 9a, 9b on the side where the electronic components 5a, 5b, 5c and the cable connection members 9a, 9b are mounted, the resin coating layer 3 is formed thick even on the side where the electronic components 5a, 5b, 5c and the cable connection members 9a, 9b are not mounted. Furthermore, in portions where the electronic components 5a, 5b, 5c and the cable connection members 9a, 9b are not present and the resin coating layer 3 is formed thin on the surface of the printed wiring board 2 on the side where the electronic components 5a, 5b, 5c and the cable connection members 9a, 9b are mounted, the resin coating layer 3 is formed thin even on the side where the electronic components 5a, 5b, 5c and the cable connection members 9a, 9b are not mounted.

As a result of this, in the resin coating layer 3 the amount of resin is almost equal on both front and back surfaces of the mounted printed wiring board 2 and hence stresses generated by the cooling and hardening are made equal on both front and back surfaces of the mounted printed wiring board 2. Therefore, in the resin encapsulated electronic component unit 1, it is possible to suppress deformation, such as bowing, of the mounted printed wiring board 2 due to the above-described stresses.

Furthermore, in the resin encapsulated electronic component unit 1 of this embodiment, the electronic components 5a, 5b, 5c and the cable connection members 9a, 9b are less apt to be subjected to the heat and pressure of the polyamide resin R and, therefore, it is possible to prevent damage by the heat and pressure.

Incidentally, although in this embodiment the above-described polyamide resin R is used as the thermoplastic resin, any resin may be used as the thermoplastic resin so long as its temperature at a surface of the mounted printed wiring board 2 during the above-described insert molding is lower than the melting temperature of a solder used in mounting the electronic components 5a, 5b, 5c. As such a thermoplastic resin it is possible to mention, for example, polyesters made by Toyobo Co., Ltd. (trade names: VYLON® HM Grade GM950, VYLON® HM Grade GAA10) and the like.

In this embodiment, the flange 6 having the attaching hole 7 as an attaching member which attaches the resin encapsulated electronic component unit 1 in a prescribed position is used. However, the above-described attaching member may be of any kind so long as it can attach the resin encapsulated electronic component unit 1 in a predetermined position. Such attaching members include, for example, a flange 6 which has no attaching hole 7 and which simply inserts the resin encapsulated electronic component unit 1 into a hole provided in a receiving portion and fixes the resin encapsulated electronic component unit 1, and the like.

1. A resin encapsulated electronic component unit comprising a rectangular printed wiring board, electronic components mounted on the board, and a resin coating layer which covers the electronic components by insert molding and encapsulates the electronic components, comprising:
a resin coating layer formed from a thermoplastic resin whose temperature at a surface of the printed wiring board during the insert molding is lower than the melting temperature of a solder used in mounting the electronic components; and
accessory members which are connected to both end portions of narrow sides of the printed wiring board and molded integrally with the resin coating layer from the thermoplastic resin;
the resin coating layer being formed by causing the thermoplastic resin to flow from the side of one accessory member to the side of the other accessory member.

2. The resin encapsulated electronic component unit according to claim 1, wherein said accessory members are attaching members which attach said resin encapsulated electronic component unit in a predetermined position.

3. The resin encapsulated electronic component unit according to claim 1, wherein said resin coating layer is disposed on both front and back surfaces of said printed wiring board and the amount of said thermoplastic resin which forms the resin coating layer is substantially symmetrically disposed on both front and back surfaces of the printed wiring board.

4. The resin encapsulated electronic component unit according to claim 3, wherein said resin coating layer has a shape which matches contours of said electronic components.

5. The resin encapsulated electronic component unit according to claim 1, wherein said solder is an alloy of Pb 60 wt % and Sn 40 wt %.

6. The resin encapsulated electronic component unit according to claim 1, wherein said thermoplastic resin is a polyamide resin.

7. A method of manufacturing a resin encapsulated electronic component unit comprising a rectangular printed wiring board, electronic components mounted on the board, a resin coating layer which covers the electronic components by insert molding and encapsulates the electronic components, the resin coating layer being formed from a thermoplastic resin whose temperature at a surface of the printed wiring board during the insert molding is lower than the melting temperature of a solder used in mounting the electronic components, and accessory members which are connected to both end portions of narrow sides of the printed wiring board and molded integrally with the resin coating layer from the thermoplastic resin,
wherein the insert molding is performed by use of a mold which comprises a cavity in which the printed wiring board is disposed, and hollow portions corresponding to the shape of the accessory members formed between each end portion on narrow sides of said printed wiring board disposed within the cavity and an inner wall of the cavity, and by injecting the thermoplastic resin into one hollow portion and discharging gases in the cavity from the other hollow portion so that the thermoplastic resin flows within the cavity longitudinally of the board.

8. The method of manufacturing a resin encapsulated electronic component unit according to claim 7, wherein said accessory members are attaching members which attach said resin encapsulated electronic component unit in a predetermined position.

9. The method of manufacturing a resin encapsulated electronic component unit according to claim 7, wherein said insert molding is performed by use of a mold having a shape which ensures that the amount of said thermoplastic resin which forms said resin coating layer disposed on both front and back surfaces of said printed wiring board is substantially symmetrically disposed on both front and back surfaces of the printed wiring board, and by disposing the printed wiring board within the cavity and simultaneously injecting said thermoplastic resin to the sides of both front and back surfaces of the printed wiring board.

10. The method of manufacturing a resin encapsulated electronic component unit according to claim 9, wherein said insert molding is performed by use of a mold comprising a cavity having a shape which matches the contour of said printed wiring board on which said electronic components are mounted.

11. The method of manufacturing a resin encapsulated electronic component unit according to claim 7, wherein said insert molding is performed by disposing within the cavity of said mold, a printed wiring board on which a plurality of mounted electronic components are longitudinally arranged and a channel of said the thermoplastic resin is provided in a middle portion of width direction, and injecting the thermoplastic resin into one hollow portion and discharging gases in the cavity from the other hollow portion so that the thermoplastic resin is guided into the channel within the cavity and flows longitudinally of the printed wiring board.

12. The method of manufacturing a resin encapsulated electronic component unit according to claim 7, wherein said solder is an alloy of Pb 60 wt % and Sn 40 wt %.

13. The method of manufacturing a resin encapsulated electronic component unit according to claim 7, wherein said thermoplastic resin is a polyamide resin.

14. A rectangular printed wiring board on which a plurality of electronic components are mounted,
wherein a plurality of the electronic components are arranged longitudinally of the printed wiring board and in a middle portion of the width direction of the printed wiring board is formed a nonmounted area which is longitudinally configured.
